(19) United States
(12) Patent Application Publication
(10) Pub. No.: US 2007/0252383 A1
(43) Pub. Date: Nov. 1, 2007

(54) Clamp Made Of Thermally Weldable Material

(76) Inventor: Michael Tappe, Duesseldorf (DE)

Correspondence Address: ST. ONGE STEWARD JOHNSTON & REENS LLC, 986 Bedford Street, Stamford, CT, 06905-5619, US

(21) Appl. No.: 11/553,840

(22) Filed: Oct. 27, 2006

Related U.S. Application Data
(63) Continuation of application No. PCT/EP05/04123, filed on Apr. 19, 2005.

(30) Foreign Application Priority Data
Apr. 27, 2004 (DE) 10 2004 020 758.5

(51) Int. Cl. F16L 53/00

(52) U.S. Cl. 285/41

(57) ABSTRACT

The invention relates to a clamp made of thermally weldable material for pipes likewise composed of a weldable material, with two segments which enclose in the assembled state the entire circumference of the pipe and can be fixed to one another by mutually facing support surfaces, as well as a heating device provided with at least one heat conductor fixed to the inner surface of at least one segment. In order to provide a clamp of simple structure which ensures a tight connection with the pipe, it is proposed according to the invention, that the heating device in the assembled state is exclusively fixed to the inner surface of one segment only and that the heating device projects on both sides over the support surfaces of said segment in the direction of the other segment.

### CROSS-REFERENCE TO RELATED APPLICATIONS

The present application is a continuation of pending International patent application PCT/EP2005/004123 filed on Apr. 19, 2005 which designates the United States and claims priority from German patent application 10 2004 020 758.5 filed on Apr. 27, 2004, the content of which is incorporated herein by reference.

### FIELD OF THE INVENTION

The invention relates to a clamp made of thermally weldable material for pipes likewise composed of a weldable material, with two segments which enclose in the assembled state the entire circumference of the pipe and can be fixed to one another by mutually facing support surfaces and with a heating device provided with at least one heat conductor fixed to the inner surface of at least one segment.

### BACKGROUND OF THE INVENTION

The employment of a clamp equipped with a heating device of thermally weldable material is known for the connection of plastic pipes, to make subsequent pipe connections as well as for repair purposes. The two-segment clamp is set on the pipe to be processed and the two segments are interconnected. Subsequently current is applied to the heating device and the interior heat conductors are heated in such a way that the two segments of the clamp effectively welded with each other and with the pipe.

In order to ensure a tight seal of the welding connection in the area of the two support surfaces of the clamp segments adjacent to each other, it is known from DE 196 23 353 C1 to provide the inner surfaces of both segments with a heating device. The heating devices are so configured that they project over the support surfaces with alternating protruding teeth and these teeth are then seated in corresponding gaps of the respective other segment. These known clamps permit a tight welding connection, however, the configuration of the heating device installed in two segments with the dovetailing tooth system is very elaborate and therefore expensive.

Starting from this situation, it is the aim of the invention to create a clamp of the type first mentioned which is of simple structure and ensures a tight connection with the pipe.

### SUMMARY OF THE INVENTION

According to the invention, the solution of this aim is characterized in that the heating device in the assembled state is exclusively fixed to the inner surface of one of the segments only and that the heating device projects on both sides over the support surfaces of said segment in the direction of the other segment.

The inventive arrangement of the heating device in one segment only of the clamp represents a significant simplification for manufacturing and handling. Because the heating device projects on both sides of the support surfaces, a tight welding connection of the clamps segments in the assembled state is guaranteed. For this the heating device projects on both sides over the support surfaces by at least 20°.

According to a preferred construction type of the invention, it is proposed that the heating device in the assembled state spans at least 70%, preferably 80% to 90%, of the circumference of the pipe.

In order to create space for the melting material of the areas of the heating device projecting over the first segment, there are recesses in the inner surface of the second segment not equipped with the heating device which essentially correspond to the thickness of the heating device for receiving the areas of the heating device projecting over the first segment.

According to a practical embodiment of the invention, it is proposed that a pipe outlet is configured on the segment equipped with the heating device, whereby a cutout is configured in the heating device corresponding to at least the internal diameter of the pipe. Due to the good material seal effectiveness of the welding connection, it is possible to select the inside diameter of the pipe outlet so that it corresponds to the inside diameter of the pipe equipped with the clamp.

Furthermore the invention proposes that centering devices are configured on the support surfaces of the segments facing each other. These centering devices, which even increase the sealing effectiveness in the area of the support surfaces, are preferably configured as projections and corresponding recesses to accept the projections at the respective opposite abutting support surfaces.

Finally this invention proposes that the heating device is made from an elastic plastic material, especially a thermoplastic material. The elasticity of the heating device material is advantageous in order to be able to bend the heating device for effective attachment to a pipe.

### BRIEF DESCRIPTION OF THE DRAWINGS

Additional characteristics and advantages of the invention can be seen with the help of the accompanying drawing which presents only an example of the practical application of a clamp of thermally weldable material according to the invention. The drawing show:

FIG. 1 a schematic side-view of a clamp according to the invention in the opened state;

FIG. 2 a schematic side-view of the clamp according to FIG. 1 in the assembled state enclosing a pipe, and

FIG. 3 a schematic top-view of a heating device.

### DETAILED DESCRIPTION OF THE INVENTION

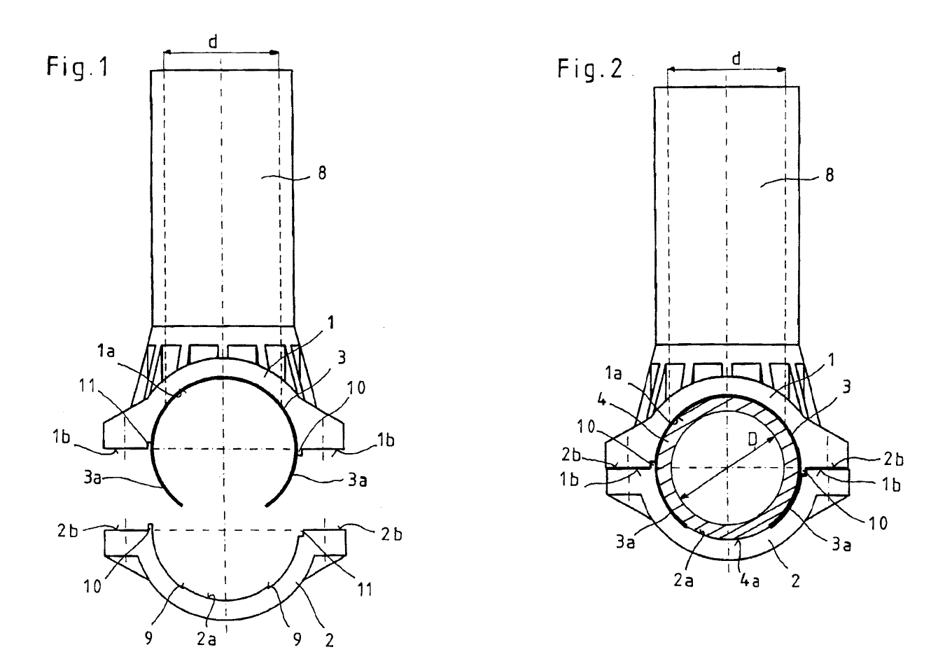

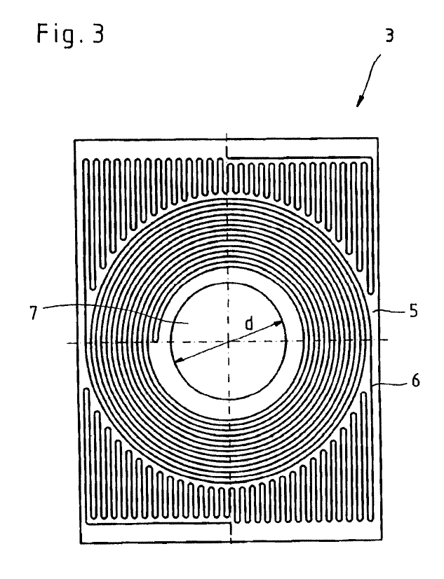

The clamp shown in FIG. 1 and FIG. 2 made of thermally weldable material for pipes likewise composed of a weldable material essentially consists of two segments 1 and 2, namely the upper segment 1 and the lower segment 2, as well as a heating device 3, which is firmly fixed to the inner surface 1a of the upper segment 1. Naturally it is also possible to firmly fix the heating device 3 to the inner surface 2a of the lower segment 2.

The illustrated construction type shows both segments 1 and 2 configured as in the cross-section semicircular segments 1 and 2. To attach the individual segments 1 and 2 on a finished installed pipe, this is the only possible construction form. If however there is the possibility or necessity of pushing up the segments 1 and 2 of the clamp on a pipe, then a segment 1 or 2 of the clamp can also have a cross section form which exceeds the semi-circular form, for example a three-quarter circle. The respective other segment 2 or 1 then shows a correspondingly smaller degree of enclosure, so that the two joined segments 1 and 2 in the assembled state completely encompasses a pipe 4, as displayed in FIG. 2.

As is furthermore evident from FIGS. 1 and 2, both segments 1 and 2 show flange-formed support surfaces 1b and 2b on both sides, on which the two segments 1 and 2 firmly contact each other in the assembled state and can be bolted with each other. Alternatively or additionally to the bolted joint it is also possible to connect the flange-formed support surfaces 1b and 2b with a pressure seal to each other, for example by a clamping.

In the construction design represented here, the segments 1 and 2 are configured as completely separate segments 1 and 2, separable from each other. Alternatively there is however also the possibility to connect the two segments 1 and 2 along the flange-like support surfaces 1b and 2b on a hinged connection pivotable to each other.

As is evident from FIG. 3, the heating device 3 located at the inner surface 1a of the upper segment 1 consists of a basic body 5, in this case rectangular, on which at least one heat conductor 6 is arranged on at least one side. The described heating device 3 in the basic body 5 shows a central cutout 7, since the upper segment 1 is provided with a pipe outlet 8. The diameter d of the cutout 7 thereby corresponds at least to the inside diameter d of the pipe outlet 8.

The heating device 3 at the inner surface 1a of the upper segment 1 is fixed in place during the manufacture of the upper segment 1. The finished heating device 3 is placed in an injection mold and subsequently the upper segment 1 is injected on the heating device 3.

As is apparent from the illustrations FIGS. 1 and 2, the heating device 3 is dimensioned in such a way that the heating device 3 projects on both sides over the support surfaces 1b of the upper segment 1 in direction of the lower segment 2, whereby areas 3a of the heating device 3 protrude over the support surfaces 1b by a protrusion of always at least 20°. As evident in FIG. 2, the heating device 3 is advantageously configured so that in the assembled state it spans at least 70%, preferably 80% to 90%, of the circumference of pipe 4. Naturally 100% enclosures are also possible, whereby the protruding areas 3a of the heating device mutually overlap the support surfaces 1b.

For receiving the areas 3a of the heating device 3 projecting over the support surfaces 1b recesses essentially corresponding to the thickness of the heating device 3 are arranged in the inner surface 2a of the lower segment 2 in such a way, that the clamp in the assembled state has an inner surface with the same diameter over the entire circumference.

In order to facilitate the joining of the two segments 1 and 2 on the one hand, but on the other hand to also improve the seal effectiveness of the clamp, centering devices are configured on the support surfaces 1b and 2b of the segments 1 and 2 facing each other. These centering devices are configured by the represented embodiment as projections 10 and corresponding recesses 11 for the acceptance of the projections 10 at the opposite support surfaces 1b, 2b.

A clamp made of a thermally weldable material configured in such a way for a pipe 4 likewise made of a weldable material composition is employed as follows:

The clamp described in FIGS. 1 and 2 is employed in order to subsequently provide a pipe 4 with a pipe outlet 8. For this the outlet 8 is molded on at the upper segment 1 of the clamp of the pipe. For the attachment of the upper segment 1 equipped with the heating device 3 on pipe 4, the areas 3a of the heating device 3 projecting over the support surfaces 1b of the upper segment 1 are bent to the outside and subsequently the upper segment 1 of the clamp is set on pipe 4. Since the basic body 5 of the heating device 3 preferably consists of an elastic plastic material, especially a thermoplastic material, the areas 3a may be bent upwards easily and without permanent deformation.

In the second step, the lower segment 2 is set on to the pipe 4 in such a way that the projections 10 and recesses 11 of the centering devices formed on the support surfaces 1b and 2b of the segments 1 and 2 facing each other mesh into one another and the overlapping areas 3a of the heating device 3 fit into the recesses 9 of the inner surface 2a of the lower segment 2. Subsequently the two segments 1 and 2 that are thus positioned exactly to each other are pressure sealed to each other with bolts.

Subsequently current is applied to at least one of the heat conductors 6 of the heating device 3. Heating up the heat conductor 6 causes not only the basic body 5 of the heating device 3, but also the inner surface 1a and 2a of the segments 1 and 2 standing in contact with the heating device 3 and the surface 4a of the pipe 4 to melt and form an effective and tight welding connection after subsequent cooling.

Due to the forming of areas 3a of the heating device 3 which significantly project over the support surfaces 1b of the upper segment 1 of the clamp, it is possible to select the inside diameter d of the pipe outlet 8 in such a way that this corresponds to the inside diameter D of the pipe 4. The areas 3a of the heating device 3 which widely overlap the contact surface of the two segments 1 and 2 ensure the tight welding of the two segments 1 and 2 in the area of the contact surface formed by the support surfaces 1b and 2b adjacent to each other.

A clamp configured in such a way is thereby distinguished by guaranteeing a tight connection with the pipe 4 with a simple structure and furthermore permitting the formation of pipe outlets 8 with a large inside diameter d.

1. Clamp made of thermally weldable material for pipes likewise composed of a weldable material, with two segments which enclose in the assembled state the entire circumference of the pipe and can be fixed to one another by mutually facing support surfaces and with a heating device provided with at least one heat conductor fixed to the inner surface of at least one segment characterized in that,
the heating device in the assembled state is exclusively fixed with the inner surface of a first segment only and that the heating device projects on both sides over the support surfaces of said segment in the direction of the other second segments.

2. Clamp according to claim 1, characterized in that the heating device projects on both sides over the support surfaces by at least 20°.

3. Clamp according to claim 1, characterized in that the heating device in the assembled state spans at least 70%, of the circumference of the pipe.

4. Clamp according to claim 1, characterized in that in the inner surface of the second segment not equipped with the heating device, recesses are arranged essentially corresponding to the thickness of the heating device for receiving the projecting areas of the heating device projecting over the first segment.

5. Clamp according to claim 1, characterized in that a pipe outlet is configured on the segment equipped with the heating device, whereby a cutout is configured in the heating device corresponding to at least the inside diameter of the pipe outlet.

6. Clamp according to claim 5, characterized in that the inside diameter of the pipe outlet corresponds to about the inside diameter of the pipe.

7. Clamp according to claim 1, characterized in that centering devices are configured on the support surfaces of the segments facing each other.

8. Clamp according to claim 7, characterized in that the centering devices are configured as projections and corresponding recesses for the acceptance of the projections at the always opposite support surfaces.

9. Clamp according to claim 1, characterized in that the heating device is made of an elastic plastic material, especially a thermoplastic material.
